(19) United States
(12) Patent Application Publication
(10) Pub. No.: US 2002/0167534 A1
(43) Pub. Date: Nov. 14, 2002

(54) Reading aid for electronic text and displays

(76) Inventor: Garrett Burke, Los Angeles, CA (US)

Correspondence Address: CISLO & THOMAS, LLP, 233 WILSHIRE BLVD, SUITE 900, SANTA MONICA, CA, 90401-1211, US

(21) Appl. No.: 09/853,969

(22) Filed: May 10, 2001

(51) Int. Cl. G09G 5/00; G06F 17/24

(52) U.S. Cl. 345/629; 707/526; 707/512

(57) ABSTRACT

A reading aid for electronic text serves to frame specific and generally desired portions of text or other displayed information for easier reading and attention-focusing purposes. In conjunction with video memory or other video signal transmission elements, an overlay generator serves to bias a portion of the video signal for a computer display. The bias is such that the framed portion of the display is made distinct from the framing portion which generally maintains its visibility and/or legibility despite opacity. In this way, the framed portion is not subject to over-isolation. While the user may scroll the opaqued portion into the framed portion of the display, the framing portion is generally visible but held in contrast or distinction to the framed portion. Adjustments may be made to the framed and framing areas, and additional features are provided.

### BACKGROUND OF THE INVENTION

1. Field of the Invention

This invention relates to computer displays and the like and more particularly to a reading aid that directs the viewer's attention to specific areas on the computer display.

2. Description of the Related Art

FIG. 1 shows a computer display, keyboard, and mouse well-known in the current art. The computer 10 generally has a CPU (central processing unit, not shown) which serves as the processing device for electronic signals, including electronic text, graphics, audio, etc. With the advances in digital information processing, any signal that can be digitized and converted into an electronic form is generally one that can be handled by a computer, including a personal computer as known in the current art. While the extent of digital signal processing and information handling has yet to be fully explored, many advantages are currently known, including the copying and transfer, as well as creation and editing, of computer text files through word processors or the like.

While word processing programs and the like make the creation and editing of text simple and easy, the reading by a person of such text through electronic means is one that is not as simple and easy. A computer display can present several different display areas for a viewer's examination, and each area may have equal validity or presence so that one area that might be of particular interest is not distinguished over any other. Under such circumstances, the text of such displays would be undifferentiated without the ability to readily distinguish between one area of text or another.

Scrolling of text is well-known in the art, where the area of display for specific text only shows a portion of the entire document. In order to see other portions of the document, a scroll bar 18 or the like is used to scroll the text under the present window vertically or horizontally, depending upon the selected scroll bar. This is a well-known standard in the Windows and Macintosh operating systems as well as other established graphic user interfaces (GUIs). While an open window enabling the viewing of a document provides some indication as to text of interest, the window does nothing to indicate specific portions of the text displayed.

With the continuing development of memory and processing technologies, resolution of computer display screens is increasing. This allows more legible text to be displayed by a single screen, making it harder to track specific text on a screen or window and making it more difficult for a person to turn away from, or leave, a particular display and return to the area of interest just prior to the person's departure. For example, if one is reviewing, reading, or editing text and then departs for lunch or the like, upon returning to the display, no indication can be given as to where the individual ended the session. While removable sticky notes or the like might be used, as well as scrolling to the last point of review, these options generally impose burdens upon the viewer that are not necessarily welcome, remembered, or consistently useful.

As electronic text becomes more of a rule than an exception, the accommodation of readers of such electronic text takes increasing precedence in order to convey the information and understanding conveyed by the text. This may be especially true for younger computer display users who are more easily distracted and would be aided by a device or system that focused the attention upon text being read.

Computer displays now take all forms and sorts including hand-held computer devices and portable digital assistance (PDAs) which may have different problems due to the “look down” style of use, the increased use of such devices, the demands of making such devices convenient, or otherwise.

Attempts have been made in the prior art to alter or enhance computer displays by a variety of schemes and methods. Some of the more pertinent are set forth below.

Gross et al., U.S. Pat. No. 6,044,385, refers to a method and system for efficiently managing the manipulation of large documents displayed within a computer screen. Referring to the Figures, a sample document 132 is placed in its entirety into the application's user window 105 regardless of the resulting legibility of said document. This patent discloses the use of a lens bar 130 which is used to delimit a region of said document 134 in which the contents of the document are rendered in a “normal”, legible manner. A user can utilize scroll bar 116 to scroll lens portion 134 of lens bar 130 through sample document 132.

Robertson et al., U.S. Pat. No. 5,670,984, is directed to an image lens for displaying an image on a display surface which preserves context and detail information when the image is compressed to fit onto a display surface. As illustrated in the drawings, a 3-D perspective view of a truncated pyramid 203 onto which a full image 200 is mapped. For the 3-D transformation, image 200 is divided into five subimages which are mapped onto the five visible faces of truncated pyramid 203. Viewing plane 214 defines what is visible from viewpoint V, and determines the eventual image to be displayed on the computer display surface 104.

The parameters of the transformations performed on a full image are derived from a description of viewpoint V, the boundaries of full image 200, the boundaries of image lens 212, and the relative distances between full image 200 at the base of truncated pyramid 203, image lens 212, view plane 214, and view point V. These parameters can be adjusted by a user to have the visual effects of moving the image lens in and out (zoom) and moving the image lens over full image 200 (pan). Furthermore, in an interactive embodiment, a user manipulates an input device, such as a mouse or a keyboard, to move the image lens over the global image. The portion of the document visible within the boundaries of the lens panel is rendered legibly, whereas the portion of the document outside the region defined by the lens panel is rendered as a 2-D projection of a 3-D trapezoid.

Winsky et al., U.S. Pat. No. 5,774,109, discloses an electronic scrolling book with temporary interruptions. Referring to the diagrams, an electronic book machine 10 includes a platform 12 which can be held by hand and which carries a keyboard 14 and a display screen 16. The platform is provided with a slot receiving a card 18 which carries a data base 20. Platform 12 carries a microprocessor 30 which implements an electronic scrolling function. More specifically, microprocessor 30 accesses memory portion 22 of data base 20 to determine text for display on screen 16 at a given scroll rate. The operator of the book machine 10 may modify the scroll rate via keyboard 14. Between a preset minimum and a preset maximum, the scroll rate may be changed in increments or steps in accordance with the number of actuations of the up or down directional key 34 or 36.

Microprocessor 30 further includes a pause marker detection module 46 which co-functions with scroll control 40 to temporarily and automatically halt the scrolling of text on display screen 16 in response to markers contained in the text. The duration of the pause and the display process varies in accordance with the kind of marker. Examples of pause markers include punctuation such as commas and periods and other normally-encountered reading pauses such as paragraph changes.

Huffman et al., U.S. Pat. No. 5,663,748, is directed to an electronic book having highlighting feature. As referenced in the diagrams, a touch screen 130 is integrated in a book-shaped housing 100 to be accessible when said housing is opened in a book-like manner. The touch screen is in communication with a processor 152 to display a page of text and/or the graphics represented by the machine-readable data. Further, the touch screen 130 acts as an input device to receive user-initiated events, and communicates these events or actions to the processor 152.

FIG. 14 is an illustration of the title page of a book wherein a pacing control option is selected by a user. The desired reading page is controlled by the user using a graphical slider bar 294. The pages of the text in the book are automatically paced by a pacing routine which is enabled or disabled by a graphical switch 296.

In FIG. 19, a user is selecting a portion of a page of text 330 by a user-initiated event of sliding his finger 212 from a first portion 332 to a second portion 334. Upon his selection, the portion 330 of the text is highlighted in a predetermined manner. An option selection dialog box 340 is displayed on the touch screen in a location out of the way of the portion 330 of the text that is marked when possible. The option selection dialog box includes a plurality of text marking options including a note-capture option 342, a highlighting option 344, a quote-capture option 346, and a set bookmark option.

Arend et al., U.S. Pat. No. 6,012,073, discloses a method and system for displaying original documents and translations thereof. As observed in the illustrations, a computer display screen 14 includes an overview screen 20 in which reduced size images 22 of a large document are rendered. When a user clicks the computer's mouse button on the page 30, the portion of that page of the document surrounding the area where the user has clicked will be displayed in the main display 12 as shown in FIG. 7.

When a user selects the translation window button 56, a translation window 16 appears over the main body 12 in the manner shown in FIG. 9. The borders of the translation window are each linked to the computer system's pointing device such that the user can “drag” the display window up and down with respect to the main display 12 in a conventional manner. Dragging the mouse cursor within the main display 12 causes the overall image to be scrolled up and down or left to right within the main display. When the display window 16 is open, the translated content is scrolled along with the main display content.

There remains a more direct solution to the problem of directing the user's attention to specific portions of a computer display and related shortcomings. It would be an advance in the art to provide means by which the certain text being read could be discriminated or highlighted during display, in order to provide better and more useful reading sessions of such electronic text. The present invention provides a solution to problems and shortcomings in the art, while providing the user enhanced utility in conjunction with adjustable parameters and other features delivering more convenience.

### SUMMARY OF THE INVENTION

In order to provide a computer screen highlighter, the present invention uses an overlay generator that interacts with the computer's video memory, so that certain selected portions of the display are held in a generally normal, clear, and legible manner, while other portions of the display are made more opaque. By delivering such a contrast, the text or display area of interest is highlighted so as to direct the user's attention to it. The overlay generator takes information regarding the screen display, such as the location of windows and the size of the display, and biases those portions of the window that should be made more opaque. The degree of opacity can be adjusted, as can the disposition and attitude of the clear or highlighted portion of the screen.

The overlay generator provides the biasing necessary to establish the frame on the computer screen as a whole or for separate windows in a graphics user interface (GUI). The parameters of the framing system may be subject to user adjustment by a variety of controls. A bookmarking submenu may be made available so that documents may be brought into a framed window according to user preferences. The overlay generator may be disposed with respect to the video memory or video data stream by a number of alternative embodiments.

Upon biasing by the overlay generator, the video display signal is then transmitted to the screen where the biasing is shown by the contrasting opacities of the clear focus area and the more opaque collateral areas.

In preferred embodiments, user adjustments include width, percentage opacity, position, and color adjustments. Additionally, a bookmarking function that allows the establishment of document and document part or location can be facilitated through the present invention.

### OBJECTS OF THE INVENTION

It is an object of the present invention to provide easier reading of computer displays.

It is yet another object of the present invention to provide easier reading of computer displays by delivering a highlighted or contrast portion of a computer display that is readily more readable than collateral areas.

It is yet another object of the present invention to provide easier reading of computer displays in an adjustable manner.

It is yet another object of the present invention to provide easier reading of electronic text that focuses the reading or attention on the document portion of current interest.

It is yet another object of the present invention to provide emphasis to document portions in an easy and convenient manner.

These and other objects and advantages of the present invention will be apparent from a review of the following specification and accompanying drawings.

### BRIEF DESCRIPTION OF THE DRAWINGS

FIG. 1 is a diagrammatic view of a computer interface system commonly used by computer users including a computer display, keyboard, and mouse.

FIG. 2 is an enhanced view of a computer screen prior to the invocation of the present invention.

FIG. 3 shows the contrasting screen portions upon invocation of the present invention as well as the control bar adjustment controls.

FIG. 4 shows an alternative display presentation as determined by the adjustment controls.

FIG. 5 is a diagrammatic view of the bookmarking feature of a computer display implementing the bookmarking feature of the present invention.

FIGS. 6-8 show alternative embodiments of logical architectural configurations, showing the relative disposition of the overlay generator with respect to the video memory and other components of the video signal transmission and display subsystem of a computer.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

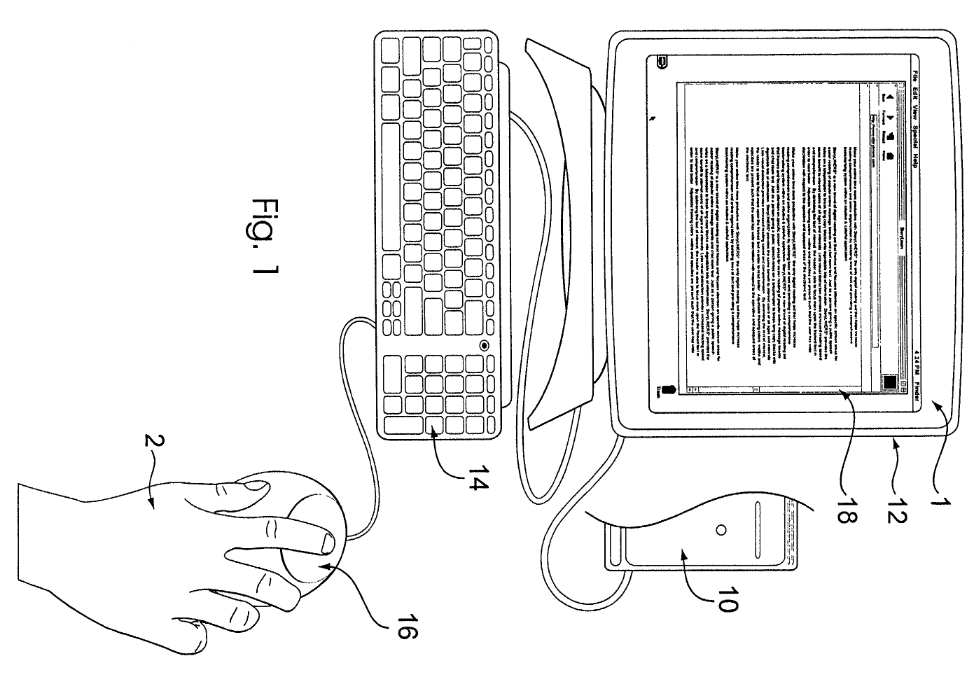

As shown in FIG. 1, the computer interface system 10 may have a computer display 12, as well as a keyboard 14 and mouse 16. The computer display 12 displays images generated or transmitted by the computer, while the keyboard 14 and mouse 16 send signals to the computer for processing and possible display on the computer display 12.

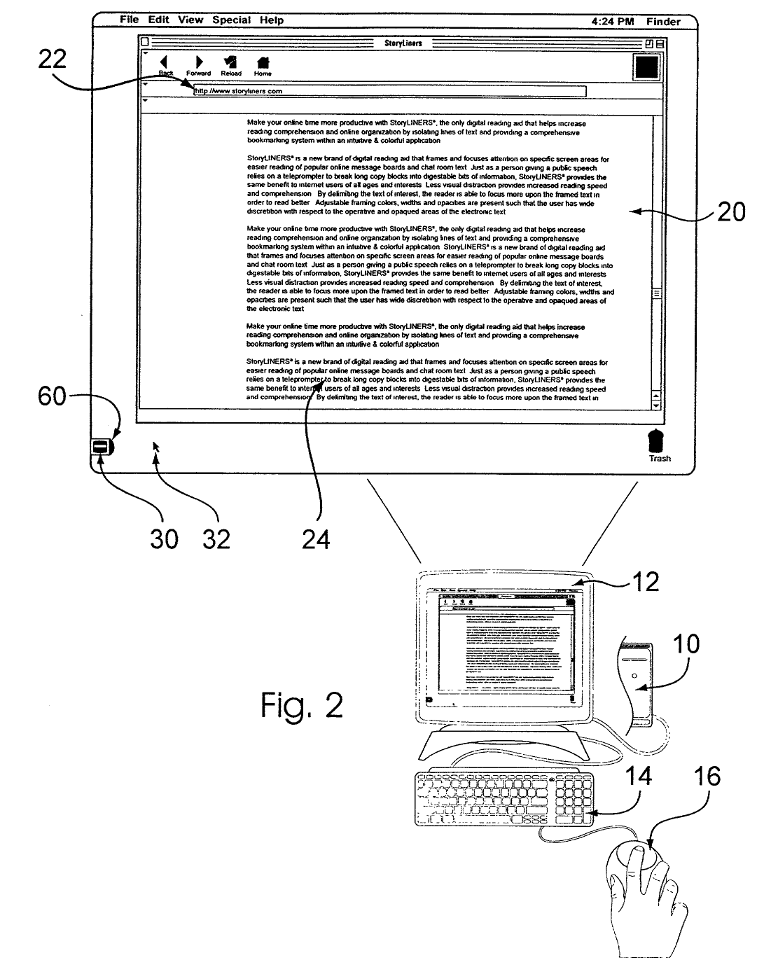

FIG. 2 shows the computer screen 20 of the computer display 12 in an enlarged view, showing a web page 22 having a significant amount of text 24. Indicated in the lower left-hand part of the computer screen 20 is an activate/deactivate toggle button 30 that serves as an invocation toggle for the Reading Aid for Electronic Text of the present invention. The activation toggle button 30 may be activated by clicking upon it as by the cursor 32 which is controlled by the mouse 16. The mouse 16 can be used to click on the activation toggle button 30 in order to invoke an instance of the present invention on the computer screen 20.

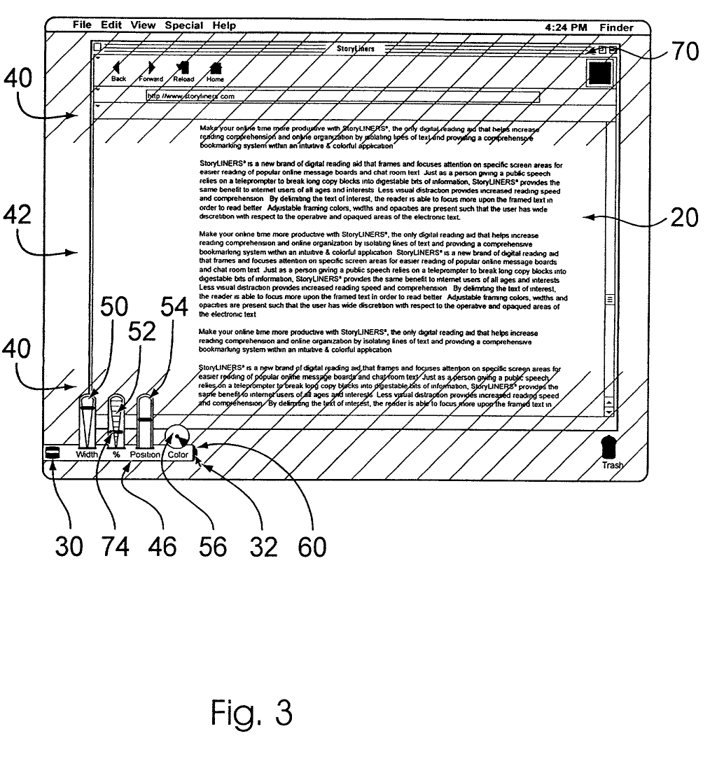

FIG. 3 shows one embodiment of the present invention when the activation toggle button 30 has been activated. Shown in FIG. 3 is the computer screen 20 with an opaque portion 40 divided by a clear portion 42. Additionally, a control bar 46 with separate adjustment controls 50, 52, 54, 56 may be controlled by the cursor 32. The control bar 46 may be extracted or replaced from the activation toggle button 30 by the cursor 32. The cursor 32 may engage the small extending tab 60. By double-clicking on the tab 60, the control bar 46 may extend to its full position. If extended, double-clicking the tab 60 may withdraw or return the control bar 46 to the activation toggle button 30. Additionally, clicking and dragging the tab 60 may serve to extend or retract the control bar 46 according to movement of the cursor.

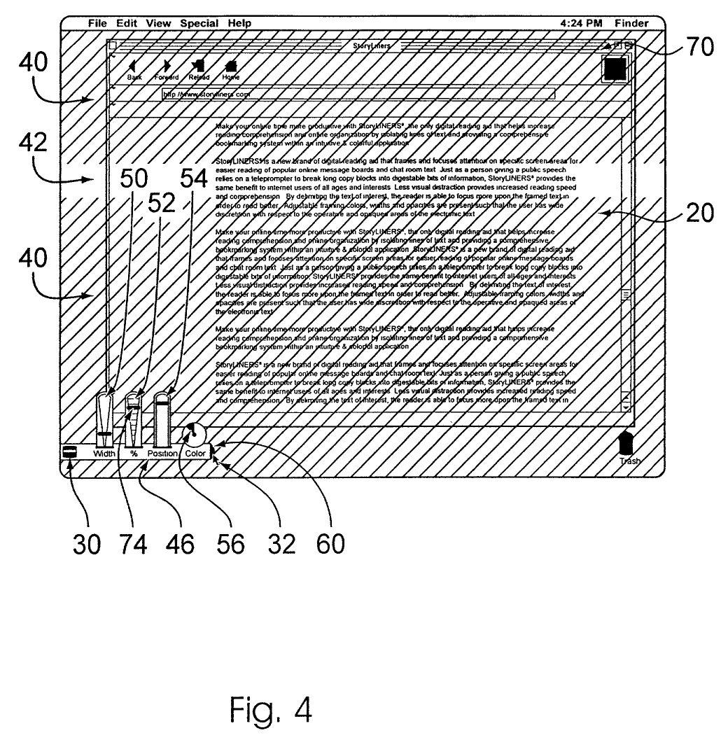

Upon invoking the activation toggle button 30 as by double-clicking upon it, a default frame 40 may be superimposed or installed upon the computer screen 20. As described in more detail below, the presence and features of the frame 40 may be achieved through interaction of the video signal via or in conjunction with the video memory or other repository video signals prior to their display. The frame 40 may be as shown in FIG. 3 with a series of diagonal lines serving to frame the framed area 42. By comparing FIGS. 3 and 4, it can be seen that the framed area 42 may be narrow or wide and the frame 40 dense or light. These characteristics may be controlled by the adjustments 50-56 of the control bar 46.

It is to be understood that the indications given in FIGS. 3 and 4 are exemplary only. For example, instead of using diagonal lines shown in FIGS. 3 and 4, a variety of other means or characteristics might be used in order to provide the frame 40. One example of this is to alter the color of the frame 40 as by biasing the video signal. As is well-known in the art, the video signal is represented numerically, and the data is interpreted in context as being that of a video signal. In order to provide the video signal, data is given with respect to each pixel on the computer screen 20. Depending upon the variety and spectrum of colors available, a pixel may be represented by 2, 8, 16, or 24 bits. By biasing the pixel's value, a frame 40 can be generated that is easily distinguished from the framed area 42 yet maintains the visibility or legibility of the original video signal subject to the frame 40.

An example of this is most dramatically seen on color displays. For displays using only 1 bit, only 2 degrees of freedom are present: on and off. This generally limits the framing capacity to either light or dark. However, with 8, 16, and/or 24 bit or other systems, a bias of approximately 10% would serve to visibly alter the display without making illegible the underlying original video signal. In an 8-bit system, there are 256 possible values for a pixel. This gives a 10% value of approximately 25, and the number 25 can be added or subtracted from the value of a pixel in order to bias the frame portion 40 to provide contrast with the framed portion 42 of the display 20. Similarly, if video signals contain pixel information with respect to luminosity, luminosity could be increased or diminished according to a predetermined or user-selectable bias. Additionally, if predictable spectrums are present within the range of values for pixel information, certain displacement or biasing could also occur that would maintain certain ones of characteristics of the framing pixels 40, so that there were some similar characteristics between the framing 40 and framed 42 portions of the display 20.

Note should be taken that while the entire computer screen 20 is shown as being either a framing portion 40 or a framed portion 42, it is also within the contemplation of the present invention that the window itself 70 is the only portion of the computer screen 20 that is subject to the Electronic Reading Aid of the present invention. In this way, the framing provided by the Reading Aid may be subject to overlap by other windows or the like or subject to minimization, restoration, and/or maximization as per standard window usage in a graphic user interface (GUI). Consequently, one of several windows could be the subject of the Reading Aid of the present invention without there being such framing with respect to the other windows and/or computer screen or desktop.

With respect to the user-selectable controls 50-56 as associated with the control bar 46, it can be seen in comparing the adjustments of FIGS. 3 and 4 that the changing of the adjustment serves to change the display characteristics of the Reading Aid of the present invention.

For example, in FIG. 3, the width adjustment 50 is set for a wider framed area 42 in FIG. 3 and a narrower framed area 42 in FIG. 4. The opacity or percentage opacity 52 is greater in FIG. 4 than in FIG. 3, and the position of the selection bar 74 for the percentage opacity adjustment 52 is correspondingly positioned for less opacity in FIG. 3 and greater opacity in FIG. 4. The position adjustment 54 is set at different positions for FIG. 3 than for FIG. 4, and the center of the framed portion 42 is likewise generally offset in an analogous manner between the two figures. The color adjustment 56 is shown at one location for FIG. 3 and a separate location for FIG. 4. While FIGS. 3 and 4 are portrayed in black and white, the use of color computer displays 12 allow for the adjustment of the color such that the user may select a preferred or desired color through the color adjustment 56 and adjust the opacity of that color by adjusting the percentage opacity adjustment 52.

Other adjustments are also within the contemplation of the present invention, such that luminosity or any other pixel characteristic could be subject to adjustment through the control bar 46. Additionally, the clear portion 42 could be controlled as by a software option to follow the cursor 32 instead of the scroll bar 18. In such an embodiment, the cursor 32 could allow the clear, or transparent, portion 42 to move in the same arbitrary fashion as the cursor 32, immediately focusing the attention of a reader or other audience upon the text or displayed file portion of interest. This application might well lend itself to online or in person instructional sessions where a computer's display is projected or transmitted for an audience's inspection and review.

Further, software control could also enable the swapping of the clear 42 and opaque 40 portions of the screen. One interface device that could enable this transformation is a small icon or other indicator in the control bar 46. Upon clicking upon this icon, the opaque 40 and clear 42 portions of the screen 20 would transpose with the opaque portion becoming clear and the clear portion becoming opaque. The formerly clear portion 42 would then become opaque and surrounded on either side by opaque portions 40 that had become clear. The activate/deactivate toggle button 30 might provide a submenu to enable this feature.

One means by which the Reading Aid of the present invention may be associated with a single window is by clicking and dragging the activation button 30 to the window of interest. An icon, marker, or the like could then be associated with the display for that window, allowing the use of the control bar 46 for that window alone. For the control of several different windows, different instances of the Reading Aid of the present invention could be invoked, one for each window the user desires to make subject to the present invention.

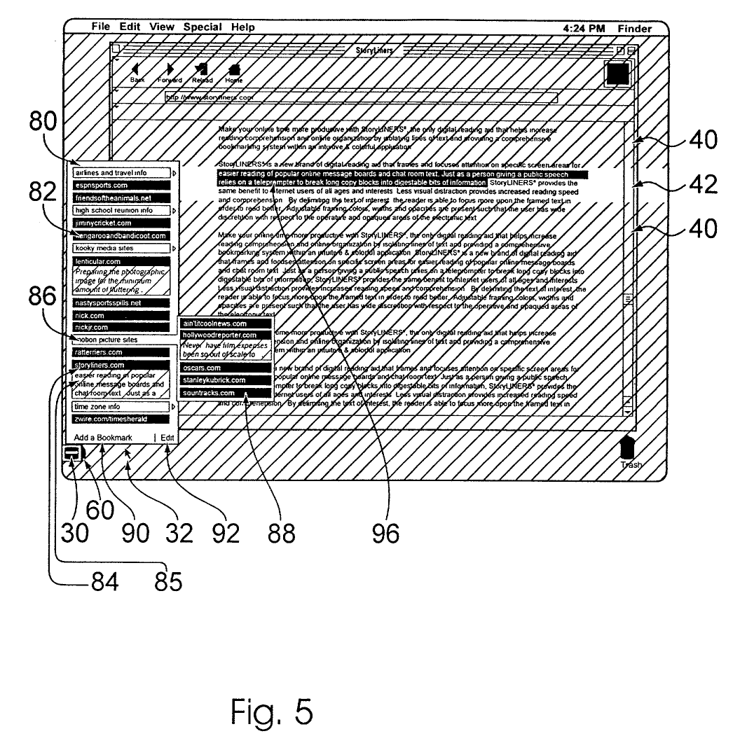

FIG. 5 shows a display similar to that of FIG. 4 where a narrow framed portion 42 is surrounded by a larger framing portion 40. In addition to the control bar extending tab 60, a bookmark submenu 80 might be made activated by the cursor 32 by clicking on a specific designated portion of the activating toggle button 30. The bookmark submenu 80 may contain a list of bookmarked sites 82 that are brought into the present window by clicking upon the site's indication on a list. For some sites 84, text that has been highlighted 85 with respect to the site may be listed below the site's entry in the bookmark submenu 80. Additionally, subfolders or submenus 86 may lead to additional listings 88 of bookmarks with indications of highlighted text. In the bookmark submenu 80, an activation area for bookmarking sites 90 may be present that activates the process by which bookmarks are added to the bookmark submenu 80. Additionally, an activation area for editing bookmarks 92 may also be present in order to edit the contents or data associations with a bookmark in the bookmark submenu 80.

In order to bookmark a site, text may be highlighted within a page and/or the cursor positioned to a certain location in a document. The Add Bookmark process is then initiated by clicking upon the bookmark activation area 90, and the document and location is then added to the database associated with the bookmark submenu 80. If any text has been highlighted 96, it may also be added to the database entry associated with the new bookmark.

As every document or resource on a computer network is generally defined uniquely with respect to the user's computer, Universal Resource Locators (URLs) can be generated for the bookmark submenu 80 in order to uniquely identify the document subject to bookmarking. In order to specifically return to a designated location inside a document, a search routine might be used in order to find the user's selected location, any highlighted text used to generate a relevant search string. Additionally, a character count or otherwise could be used, as well as a numeric indication of the extension of any highlighting present. Other means known in the art may also be used in order to define a location to which the user may care to return, such that he or she would care to bookmark that location in a document.

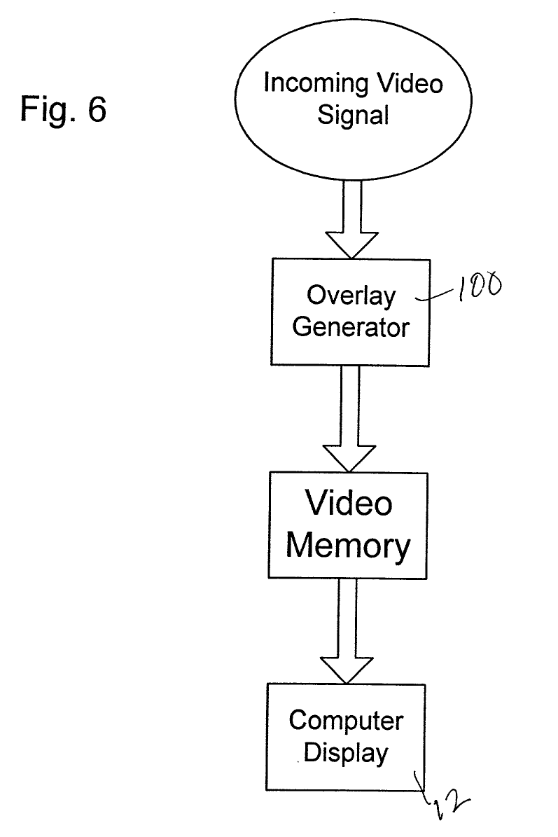

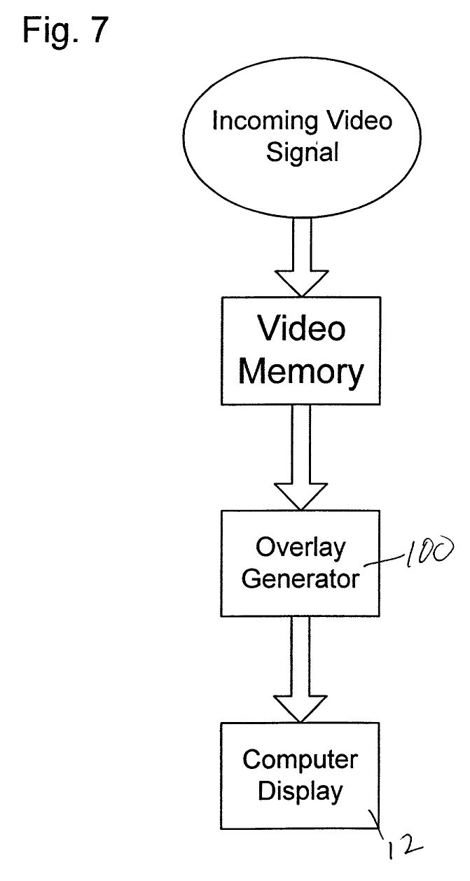

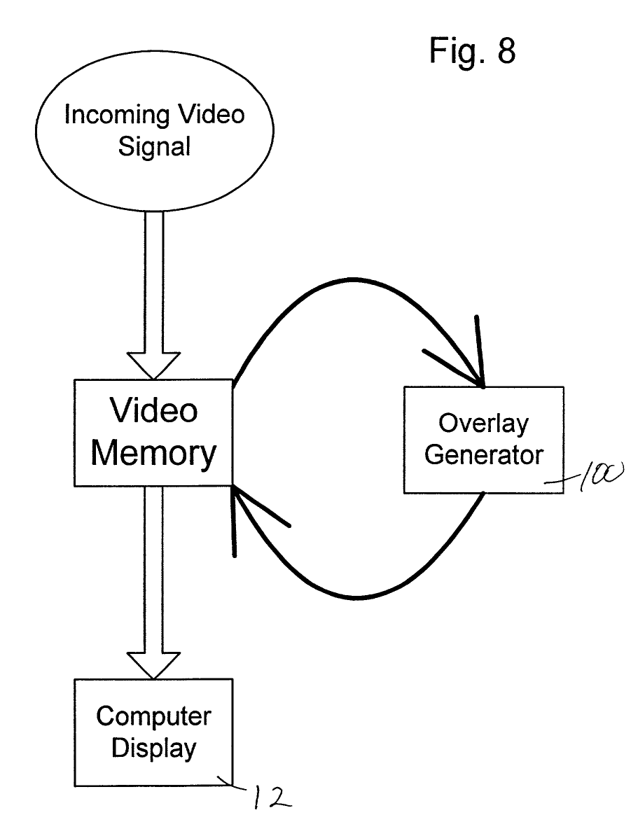

FIGS. 6-8 show basic logical configurations with respect to the overlay generator 100. In FIG. 6, the overlay generator 100 generates a bias that is then incorporated by the video memory prior to transmission of the computer display 12. In FIG. 7, the biasing occurs after the video memory transmits its video signal. In FIG. 8, the overlay generator 100 operates in conjunction with the video memory in order to provide a biased framing signal to the computer display 12.

The present invention may be realized in a number of different embodiments and may be used in conjunction with a number of different operating systems. Using portable computer languages such as JAVA and C, the present invention may be coded and implemented on a variety of different microprocessors running a number of different operating systems. These include microprocessors by Motorola and Intel, as well as operating systems for use on PCs based upon Microsoft's Windows operating system or otherwise, the Macintosh operating system or other operating systems as marketed by Apple Computers, Linux, Unix, and others that are now known or later developed.

Also, while a horizontal embodiment for the English language has been shown herein, alternative embodiments within the contemplation of the present invention include the use of other languages and framed area geometries including vertical framing of Asian characters or ideograms for Asian-language texts.

The present invention provides excellent means by which electronic text can be presented for public viewing for an audience of several people. Additionally, the present invention may be used in conjunction with programmed reading exercises or other reading activities so that certain portions of a document are highlighted in contrast to others. In one embodiment, the framed portion may move over the text to force the reader to read at a certain rate or to promote continuous or speed-reading. In this way, the student's reading abilities may be exercised and developed by means of electronic image displays. Due to the possible ubiquity and convenience of such electronic displays, the Reading Aid of the present invention provides a significant advantage over other systems and delivers to the reader means by which text can be contrasted for leisure reading for enjoyment, technical reading for professional purposes or otherwise.

While the present invention has been described with regards to particular embodiments, it is recognized that additional variations of the present invention may be devised without departing from the inventive concept.

What is claimed is:

1. A highlighter for electronic text displayed via video memory storing display data, comprising:
an overlay generator, said overlay generator providing partial overlay data for use in conjunction with the display data, said partial overlay data serving to make partially opaque a first portion of display data when the display data is displayed, said partial overlay data generally maintaining legibility of the display data, said partial overlay data indicating a second portion of the display data that is not made partially opaque by said partial overlay data; whereby
said second clear portion is made more prominent by contrast with said first, more opaque portion to more easily direct a viewer's eye to said second clear portion.

2. The highlighter for electronic text as set forth in claim 1, wherein said first portion made opaque lies on opposite sides of said second portion.

3. The highlighter for electronic text as set forth in claim 1, wherein said overlay generator is a software application affecting the display data.

4. The highlighter for electronic text as set forth in claim 1, wherein said overlay generator further comprises:
at least one adjustment available to a viewer of the display data.

5. The highlighter for electronic text as set forth in claim 4, wherein said adjustment is selected from the group consisting of:
a width adjustment;
an opacity adjustment;
a position adjustment; and
a color adjustment.

6. The highlighter for electronic text as set forth in claim 5, further comprising:
said width adjustment adjusting a width of said second clear portion;
said opacity adjustment adjusting a degree of opacity of said first opaque portion;
said position adjustment adjusting a position of said second clear portion;
said color adjustment adjusting a color of said first opaque portion.

7. The highlighter for electronic text as set forth in claim 1, wherein said overlay generator enables scrolling of the display data beneath said first and second overlay portions to highlight other portions of a document associated with the display data.

8. The highlighter for electronic text as set forth in claim 1, wherein said overlay generator enables movement of said second clear portion associate with movement of a cursor.

9. The highlighter for electronic text as set forth in claim 1, wherein said overlay generator enables transposition of said second clear portion with said first opaque portion and said first opaque portion with said second clear portion.

10. The highlighter for electronic text as set forth in claim 1, wherein said overlay generator further comprises:
a bookmark utility, said bookmark utility including a bookmark database, said bookmark database having an entry indicating a point of interest in a document for display in conjunction with said overlay generator.

11. The highlighter for electronic text as set forth in claim 10, wherein said bookmark utility further comprises:
a bookmark control utility, said bookmark control utility having operations selected from the group consisting of bookmark creation, retrieval, editing and deletion utilities.

12. The highlighter for electronic text as set forth in claim 11, wherein said bookmark creation utility further comprises:
said bookmark creation utility creates a first bookmark for entry into said bookmark database by indicating a portion of a displayed document and entering information associated with said highlighted portion of said displayed document into said bookmark database.

13. The highlighter for electronic text as set forth in claim 11, wherein said bookmark retrieval utility further comprises:
said bookmark retrieval utility retrieving a second bookmark from said bookmark database, retrieves and opens a document associated with said second bookmark, and positions said second bookmark for display in said second clear portion of the display data.

14. The highlighter for electronic text as set forth in claim 13, wherein said bookmark retrieval utility further comprises:
said bookmark retrieval utility indicating a portion of said opened document originally indicated when said second bookmark was created.

15. The highlighter for electronic text as set forth in claim 13, wherein said bookmark retrieval utility further comprises:
a list of bookmarks present in said bookmark database; and
indicated text associated with a particular one of said bookmarks in said list.

16. The highlighter for electronic text as set forth in claim 15, wherein said bookmark retrieval utility further comprises:
said indicated text displayed when said particular one bookmark is indicated for possible selection.

17. A highlighter for electronic text displayed via video memory storing display data, comprising:
an overlay generator, said overlay generator being a software application affecting the display data, said overlay generator providing partial overlay data for use in conjunction with the display data, said partial overlay data serving to make partially opaque a first portion of display data when the display data is displayed, said partial overlay data generally maintaining legibility of the display data, said partial overlay data indicating a second portion of the display data that is not made partially opaque by said partial overlay data;
said first portion made opaque generally lying on opposite sides of said second portion;
said overlay generator having at least one adjustment available to a viewer of the display data selected from the group consisting of:
a width adjustment;
an opacity adjustment;
a position adjustment; and
a color adjustment;
said overlay generator enabling scrolling of the display data beneath said first and second overlay portions to highlight other portions of a document associated with the display data;
said overlay generator enabling movement of said second clear portion associate with movement of a cursor;
said overlay generator enabling transposition of said second clear portion with said first opaque portion and said first opaque portion with said second clear portion;
said overlay generator having a bookmark utility, said bookmark utility including a bookmark database, said bookmark database having an entry indicating a point of interest in a document for display in conjunction with said overlay generator;
said bookmark utility having a bookmark control utility, said bookmark control utility having bookmark creation, retrieval, editing and deletion utilities;
said bookmark creation utility creating a first bookmark for entry into said bookmark database by indicating a portion of a displayed document and entering information associated with said highlighted portion of said displayed document into said bookmark database;
said bookmark retrieval utility retrieving a second bookmark from said bookmark database, retrieves and opens a document associated with said second bookmark, and positions said second bookmark for display in said second clear portion of the display data, said bookmark retrieval utility indicating a portion of said opened document originally indicated when said second bookmark was created; and
said bookmark retrieval utility including a list of bookmarks present in said bookmark database and indicated text associated with a particular one of said bookmarks in said list, said indicated text displayed when said particular one bookmark is indicated for possible selection; whereby
said second clear portion is made more prominent by contrast with said first, more opaque portion to more easily direct a viewer's eye to said second clear portion.

18. The highlighter for electronic text as set forth in claim 17, further comprising:
said width adjustment adjusting a width of said second clear portion;
said opacity adjustment adjusting a degree of opacity of said first opaque portion;
said position adjustment adjusting a position of said second clear portion;
said color adjustment adjusting a color of said first opaque portion.

19. A method for enhancing a video display for viewing, the steps comprising:
making opaque a first portion of a video display, said video display presenting information displayed for viewing;
generally maintaining legibility of displayed information subject to said first portion of said video display made opaque; and
providing a second portion of said video display free from opacity, said second portion of said video display being clear; whereby
said second clear portion of said video display is made more prominent in contrast to said first portion, to more easily direct a viewer's eye to said second clear portion.

20. The method for enhancing a video display for viewing as set forth in claim 19, wherein said first portion made opaque lies on opposite sides of said second portion.

21. The method for enhancing a video display for viewing as set forth in claim 19, the steps further comprising:
providing an overlay generator, said overlay generator providing a partial overlay signal for use in conjunction with said video display, said partial overlay signal serving to make partially opaque said first portion of said video display, said partial overlay signal indicating said second portion of said video display that is free from opacity made by said partial overlay signal.

22. The method for enhancing a video display for viewing as set forth in claim 21, wherein said partial overlay signal further comprises:
partial overlay data used in conjunction with display data, said display data transmitted as said video display.

23. The method for enhancing a video display for viewing as set forth in claim 21, wherein said overlay generator is a software application affecting said video display.

24. The method for enhancing a video display for viewing as set forth in claim 19, the steps further comprising:
providing at least one adjustment available to a viewer of said video display.

25. The method for enhancing a video display for viewing as set forth in claim 24, wherein said adjustment is selected from the group consisting of:
a width adjustment;
an opacity adjustment;
a position adjustment; and
a color adjustment.

26. The method for enhancing a video display for viewing as set forth in claim 25, further comprising:
said width adjustment adjusting a width of said second clear portion;
said opacity adjustment adjusting a degree of opacity of said first opaque portion;
said position adjustment adjusting a position of said second clear portion; and
said color adjustment adjusting a color of said first opaque portion.

27. The method for enhancing a video display for viewing as set forth in claim 19, further comprising:
scrolling said information presented for viewing beneath said first and second overlay portions to highlight other portions of a document associated with said presented information.

28. The method for enhancing a video display for viewing as set forth in claim 19, further comprising:
moving said second clear portion in association with movement of a cursor.

29. The method for enhancing a video display for viewing as set forth in claim 19, further comprising:
transposing said second clear portion with said first opaque portion and said first opaque portion with said second clear portion.

30. The method for enhancing a video display for viewing as set forth in claim 19, further comprising:
providing a bookmark utility, said bookmark utility including a bookmark database, said bookmark database holding an entry, said entry indicating a point of interest in a document for display as presented information displayed for viewing.

31. The method for enhancing a video display for viewing as set forth in claim 30, said bookmark utility further comprising:
a bookmark control utility, said bookmark control utility having bookmark creation, retrieval, editing and deletion utilities;
said bookmark creation utility creating a first bookmark for entry into said bookmark database by indicating a portion of a displayed document and entering information associated with said highlighted portion of said displayed document into said bookmark database;
said bookmark retrieval utility retrieving a second bookmark from said bookmark database, retrieves and opens a document associated with said second bookmark, and positions said second bookmark for display in said second clear portion of said display data, said bookmark retrieval utility indicating a portion of said opened document originally indicated when said second bookmark was created;
said bookmark retrieval utility including a list of bookmarks present in said bookmark database and indicated text associated with a particular one of said bookmarks in said list, said indicated text displayed when said particular one bookmark is indicated for possible selection.

32. A method for enhancing a video display for viewing, the steps comprising:
providing an overlay generator in the form of a software application, for use in conjunction with a video display, said video display presenting information displayed for viewing;
said overlay generator providing a partial overlay signal for use in conjunction with said video display, said partial overlay signal making opaque a first portion of said video display while generally maintaining legibility of said displayed information subject to said first portion of said video display made opaque, said partial overlay signal providing a second portion of said video display free from opacity, said second portion of said video display being clear and generally free from opacity, said partial overlay signal including partial overlay data used in conjunction with display data transmitted as said video display;
said first portion made opaque lying on opposite sides of said second portion;
providing at least one adjustment available to a viewer of said video display said adjustment is selected from the group consisting of:
a width adjustment;
an opacity adjustment;
a position adjustment; and
a color adjustment;
scrolling said information presented for viewing beneath said first and second overlay portions to highlight other portions of a document associated with said presented information;
moving said second clear portion in association with movement of a cursor;
transposing said second clear portion with said first opaque portion and said first opaque portion with said second clear portion; and
providing a bookmark utility, said bookmark utility including a bookmark database, said bookmark database holding an entry, said entry indicating a point of interest in a document for display as presented information displayed for viewing, said bookmark utility including a bookmark control utility, said bookmark control utility having bookmark creation, retrieval, editing and deletion utilities, said bookmark creation utility creating a first bookmark for entry into said bookmark database by indicating a portion of a displayed document and entering information associated with said highlighted portion of said displayed document into said bookmark database, said bookmark retrieval utility retrieving a second bookmark from said bookmark database, retrieves and opens a document associated with said second bookmark, and positions said second bookmark for display in said second clear portion of said display data, said bookmark retrieval utility indicating a portion of said opened document originally indicated when said second bookmark was created, said bookmark retrieval utility including a list of bookmarks present in said bookmark database and indicated text associated with a particular one of said bookmarks in said list, said indicated text displayed when said particular one bookmark is indicated for possible selection; whereby
said second clear portion of said video display is made more prominent in contrast to said first portion, to more easily direct a viewer's eye to said second clear portion.

33. The method for enhancing a video display for viewing as set forth in claim 32, further comprising:
said width adjustment adjusting a width of said second clear portion;
said opacity adjustment adjusting a degree of opacity of said first opaque portion;
said position adjustment adjusting a position of said second clear portion; and
said color adjustment adjusting a color of said first opaque portion.
